(19) United States
(12) Patent Application Publication
(10) Pub. No.: US 2011/0261079 A1
(43) Pub. Date: Oct. 27, 2011

(54) AUTOMATIC ADJUSTMENT OF A USER INTERFACE COMPOSITION

(75) Inventors: Michael Ingrassia, JR., San Jose, CA (US); Allen P. Haughay, JR., Morgan Hill, CA (US); Benjamin Rottler, San Francisco, CA (US)

(73) Assignee: Apple Inc., Cupertino, CA (US)

(21) Appl. No.: 12/764,751

(22) Filed: Apr. 21, 2010

(51) Int. Cl. G09G 5/373; A63B 71/00

(52) U.S. Cl. 345/665; 482/8

(57) ABSTRACT

This is directed to dynamically adjusting a display based on the progress of an event monitored by an electronic device. In particular, this is directed to dynamically adjusting workout information displayed as a user nears the end of a workout. In some cases, an electronic device can display information corresponding to an event. The user may wish to see specific event information to monitor the user's performance in the event. As the event nears its completion, however, the user may wish to view different information related to the user's performance. The electronic device can dynamically adjust the display to replace the initially displayed information with the different information without requiring a user input. This may be particularly valuable when a user is running and has a limited ability to interact with the device during the run.

### BACKGROUND

This is directed to automatically adjusting elements displayed on a user interface. In particular, this is directed to automatically adjusting elements displayed on a user interface based on a sensor output and on the approach of an event.

Many electronic devices can include displays on which information can be provided to a user. The amount of information displayed, as well as the distribution of the information on the display, can be set by an application, firmware or an operating system running on the device, or combinations of these. The information provided can have any suitable prominence, including for example different sizes or location based on the relative importance of the information.

In some cases, a user can perform an activity while using the electronic device, where the activity requires either the user to move relative to the device, or the device to move relative to the user. For example, a user can run or walk while holding the electronic device. As another example, a user can move a device to provide an input corresponding to an application (e.g., a game). When the device moves relative to the user's eyes, the user may have difficulty viewing content on the display. In particular, the user may have difficulty discerning information provided with smaller types, information disposed near edges or corners of the display, or information in a color similar to a background color.

To improve a user's ability to view information of interest, the electronic device can automatically adjust the information displayed based on the relative movement of the device. For example, in response to detecting that the device is moving more than a threshold amount, the electronic device can automatically adjust the size, disposition, and content provided on the display. For example, the electronic device can identify the particular content that is most relevant to the user, and display the particular content in a prominent position using a large type.

In some cases, however, the particular content of most interest to a user can change while the device moves relative to the user. To change the most prominent content displayed, or to display more prominently different content, a user may be required to provide a corresponding input. This may be difficult for the user to do as the user moves, or may be distracting if the user is concentrated on a particular task at hand.

### SUMMARY

This is directed to automatically changing the prominence of displayed information while a device moves based on the occurrence of an event or on nearing the termination of an event. In particular, this is directed to adjusting information corresponding to an event that is displayed, where the event information of interest changes as the event nears its completion (e.g., when the user nears a workout target or goal).

Using an electronic device, a user can view information related to one or more events. For example, a user can view information related to an ongoing workout tracked by the device. When the user moves relative to the device (e.g., as the user runs), the user may have difficulty viewing displayed information. The electronic device can therefore automatically adjust the prominence of displayed workout information in response to determining (e.g., from a sensor) that the device is moving.

When the user reaches an event, however, the user may be interested in different information than was initially provided on the display. For example, a user may be more interested in pace or time information towards the end of a distance-based workout. Accordingly, the electronic device can monitor the data stream corresponding to the event and detect when the data stream reaches a threshold corresponding to the end of the event. In response to determining that the event end is approaching, the electronic device can identify other information to display, and replace the initially displayed information with different workout information.

In some embodiments, the electronic device can adjust the displayed information based on an event that spans several shorter events. For example, the electronic device can adjust a display in response to detecting a milestone workout event that is reached over several workouts. In particular, the electronic device can adjust a display when distance, pace, or time milestones are met. As another example, the electronic device can adjust a display when a fitness goal or coach-defined goal is met.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an electronic device for dynamically adjusting displayed information in accordance with one embodiment of the invention;

FIG. 2 is a schematic view of an illustrative display for selecting a workout in accordance with one embodiment of the invention;

FIG. 3 is a schematic view of an illustrative display provided in response to receiving a user selection of a distance-based workout option in accordance with one embodiment of the invention;

FIG. 4 is a schematic view of an illustrative display for providing information corresponding to an ongoing workout in accordance with one embodiment of the invention;

FIG. 5 is a block diagram of electronic device modules for adjusting a device display in accordance with one embodiment of the invention;

FIG. 6 is a schematic view of an illustrative electronic device display in which the prominence of displayed content is adjusted based on device movement in accordance with one embodiment of the invention;

FIG. 7 is a schematic view of an illustrative display of information provided when the device moves in accordance with one embodiment of the invention;

FIG. 8 is a schematic view of an illustrative electronic device display that is automatically adjusted based on a workout progress in accordance with one embodiment of the invention;

FIG. 9 is a schematic view of an illustrative display for defining a type of information and a threshold for dynamically adjusting the information displayed by a device in accordance with one embodiment of the invention;

FIG. 10 is a schematic view of an illustrative display for providing information corresponding to a milestone event in accordance with one embodiment of the invention;

FIG. 11 is a flowchart of an illustrative process for dynamically adjusting a display of a device used in a workout in accordance with one embodiment of the invention;

FIG. 12 is a flowchart of an illustrative process for dynamically adjusting a display based on an event; and

FIG. 13 is a flowchart of an illustrative process for adjusting a display provided during a workout in accordance with one embodiment of the invention.

### DETAILED DESCRIPTION

An electronic device operative to dynamically adjust content displayed to a user is provided. In particular, an electronic device operative to monitor a changing quantity associated with an event (e.g., a workout defined by a target) can automatically adjust the content displayed by the device as the changing quantity approaches a threshold (e.g., corresponding to the end of a workout).

In some situations, a user can move the electronic device relative to the user's eyes. For example, during a workout (e.g., while running or walking), a user may not hold the electronic device steady. This may prevent the user from accurately viewing information provided by the display. Accordingly, the electronic device can adjust the composition of the display to account for the device movement. For example, the electronic device can identify one or more particular items of information that are more important, and adjust the prominence and size of the more important items of information.

The movement of the device can, in some cases, correspond or relate to an event characterized by a changing quantity. Using the electronic device, a user can define start and stop conditions for the event, and direct the device to monitor the event progress. For example, the user can define a workout having a target distance, pace, time, or calories burned. The electronic device can monitor a data stream corresponding to the event, and compare the evolution in the data with a target value corresponding to the end of the event. When the data approaches the target value, the electronic device can modify the displayed information to reflect the approach of the end of the event.

The electronic device can display any suitable information corresponding to the event. For example, the electronic device can adjust a display to provide information corresponding to the data stream used to define the event end (e.g., change a display from pace to time remaining in a time-based workout). As another example, the electronic device can adjust the display to provide information corresponding to a user's target goal, which may be different than the event start and end criteria (e.g., display the total distance run by a user in a time-based workout).

In some embodiments, the information displayed by the device can be independent of a current event (e.g., a current workout), but be adjusted based on an ongoing event. For example, the information displayed can correspond to a long-term workout goal or milestone. In particular, the electronic device can switch the display from information corresponding to the immediate workout (e.g., the current pace or distance covered in the current workout) to information corresponding to the long-term goal (e.g., run a distance, a fastest mile, or a longest current run). In such cases, the electronic device can dynamically adjust a display based on a different event than the current event, including at times independent of the end of the current event.

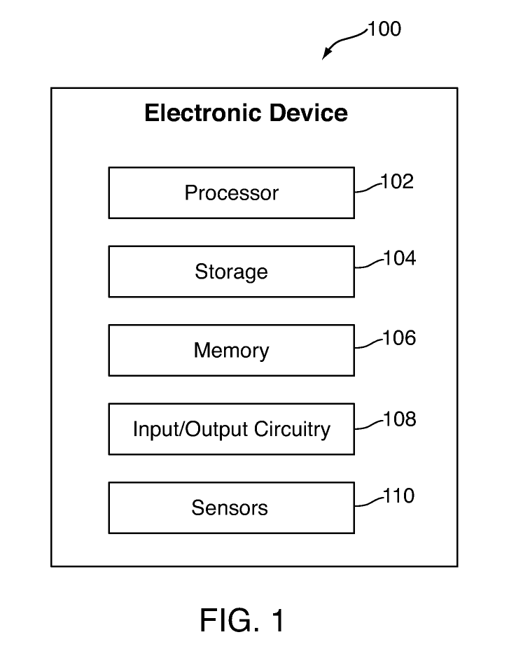

FIG. 1 is a schematic view of an electronic device for dynamically adjusting displayed information in accordance with one embodiment of the invention. Electronic device 100 may include control circuitry or processor 102, storage 104, memory 106, input/output interface 108, and sensors 110. In some embodiments, one or more of electronic device components 100 may be combined or omitted (e.g., combine storage 104 and memory 106, or omit sensor array 110). In some embodiments, electronic device 100 may include other components not combined or included in those shown in FIG. 1 (e.g., communications circuitry, a power supply or a bus), or several instances of the components shown in FIG. 1. For the sake of simplicity, only one of each of the components is shown in FIG. 1.

Processor 102 can include any processing circuitry or processor operative to control the operations and performance of electronic device 100. Storage 104 can include, for example, one or more storage mediums including a hard-drive, solid state drive, flash memory, permanent memory such as ROM, any other suitable type of storage component, or any combination thereof. Memory 106 can include cache memory, semi-permanent memory such as RAM, and/or one or more different types of memory used for temporarily storing data. In some embodiments, memory 106 and storage 104 can be combined as a single storage medium. Input/output circuitry 108 can be operative to convert (and encode/decode, if necessary) analog signals and other signals into digital data.

Input/output interface 108 can convert (and encode/decode, if necessary) analog signals and other signals into digital data. For example, input/output interface 108 may receive and convert physical contact inputs (e.g., from a multi-touch screen or a button press), physical movements (e.g., from a mouse or sensor), analog audio signals (e.g., from a microphone), or any other input provided by a user. Although input/output interface 108 is illustrated in FIG. 1 as a single component of electronic device 100, several instances of input/output interface 108 can be included in electronic device 100.

Electronic device 100 can include any suitable mechanism, circuitry or component for allowing a user to provide inputs to input/output interface 108. For example, electronic device 100 may include a button, keypad, dial, a click wheel, or a touch interface (e.g., a capacitive touch screen), or combination of these. In some embodiments, input/output information 108 can instead or in addition include circuitry, software, firmware, or other components for detecting and processing voice inputs or other audio inputs. In some cases, input/output interface 108 can be operative to detect and process inputs received from gestures of the device (e.g., inputs detected from movements of the device, such as shaking, twisting or spinning).

Electronic device 100 can include specialized output interface associated with output signals such as, for example, one or more audio or visual outputs. An audio output may include one or more speakers (e.g., mono or stereo speakers) built into electronic device 100, or an audio component that is remotely coupled to electronic device 100 (e.g., a headset, headphones or earbuds that may be coupled to communications device with a wire or wirelessly). A visual output can include display circuitry (e.g., a screen or projection system) for providing a display visible to the user. For example, the display circuitry can include a screen (e.g., an LCD screen) that is incorporated in electronics device 100, a movable display or a projecting system for providing a display of content on a surface remote from electronic device 100 (e.g., a video projector), or combinations of these. In some embodiments, input/output interface 108 can include a coder/decoder (Codec) to convert digital media data into analog signals such as, for example, video Codecs, audio Codecs, or any other suitable type of Codec.

Sensors 110 can include any suitable sensor or sensor array for detecting or capturing attributes of the device environment. For example, sensors 110 can include one or more sensors integrated into a device, or coupled to the device via a remote interface (e.g., providing an output describing the environment via a wired or wireless connection). Sensors 110 can include any suitable type of sensor, including for example a camera, microphone, motion sensing component, positioning circuitry, physiological sensing component, thermometer, hygrometer, proximity sensor, IR sensor, magnetometer, or any other type of sensor for detecting characteristics of a user or of the user's environment

In some embodiments, sensors 110 can include one or more inertial measurement units (IMU) for detecting movements of electronic device 100. In some embodiments, an IMU can include one or more three-axes acceleration motion sensors (e.g., an accelerometer) operative to detect linear acceleration in three directions (i.e., the x or left/right direction, the y or up/down direction, and the z or forward/backward direction). As another example, an IMU can include one or more two-axis acceleration motion sensors which can be operative to detect linear acceleration only along each of x or left/right and y or up/down directions (or any other pair of directions). In some embodiments, an IMU can include an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

In some embodiments, the IMU can directly detect rotation, rotational movement, angular displacement, tilt, position, orientation, motion along a non-linear (e.g., arcuate) path, or any other non-linear motions. For example, if the IMU is a linear motion sensor, additional processing can be used to indirectly detect some or all of the non-linear motions. For example, by comparing the linear output of the motion sensor with a gravity vector (i.e., a static acceleration), the motion sensor can calculate the tilt of electronic device 100 with respect to the y-axis. In some embodiments, the motion sensor can instead or in addition include one or more gyro-motion sensors or gyroscopes for detecting rotational movement. For example, an IMU can include a rotating or vibrating element.

In the following discussion, events monitored by the electronic device will be described in the context of workouts initiated by a user. It will be understood, however, that embodiments described below can apply to any suitable event, including for example events characterized by a changing value of a data stream (e.g., time, location, or position along a sequence) that the device can monitor.

Using an electronic device, a user can monitor a workout performance for later analysis. In particular, an electronic device can include or be coupled to appropriate sensors for monitoring a user's progress as the user runs. For example, an electronic device can be in communication with a motion sensor embedded in a user's shoe. As another example, a motion detection component in the electronic device can detect movement corresponding to the user's running or walking.

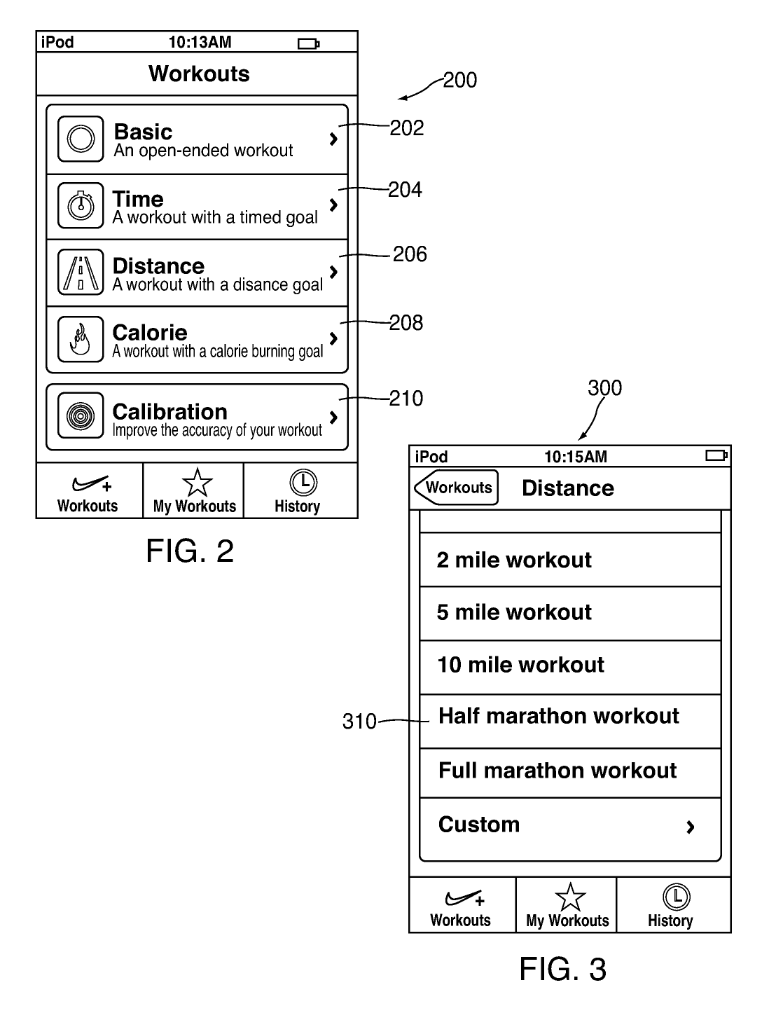

The user can initiate a workout using any suitable approach. In some embodiments, the user can select one or more displayed options to start a workout. FIG. 2 is a schematic view of an illustrative display for selecting a workout in accordance with one embodiment of the invention. Display 200 can include options 202, 204, 206 and 208 for initiating different types of workouts. For example, display 200 can include option 202 for initiating a basic workout, option 204 for initiating a time-based workout (e.g., a workout duration), option 206 for initiating a distance-based workout (e.g., a workout length), and option 208 for initiating a calories-based workout (e.g., an amount of energy expended by the user). In response to selecting one of the options, the electronic device can provide a listing of options corresponding to the workout type.

FIG. 3 is a schematic view of an illustrative display provided in response to receiving a user selection of a distance-based workout option in accordance with one embodiment of the invention. Display 300 can be provided at any suitable time, including for example in response to receiving a user selection of option 206 (FIG. 2). Display 300 can include listing 310 of distances that a user can select to run. Similarly, display 300 can include listings of durations, calories, heart rate, VO2max (or other measure of a user's breathing), or other measurable quantities that correspond to a user's workout or can be measured in relation with a workout. The measurable quantities can be provided in any suitable unit, including for example several units (e.g., both English units and SI units). In response to receiving a selection from listing 310, the electronic device can begin a workout terminating when the quantity selected in listing 310 is reached.

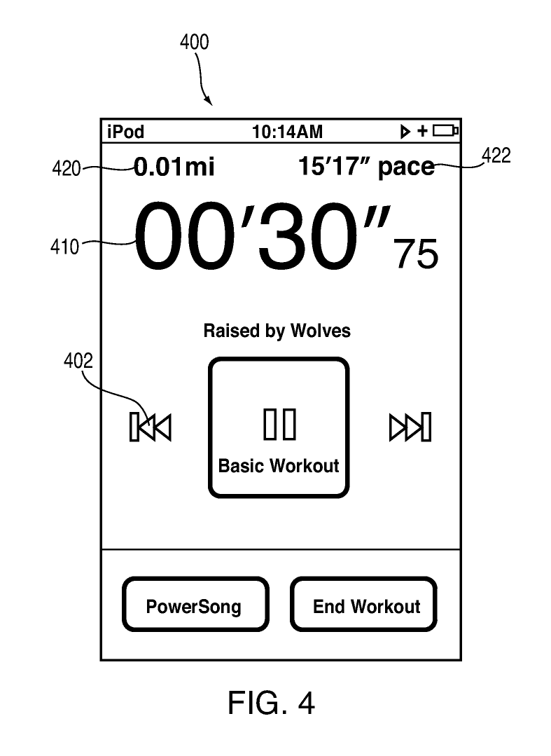

The electronic device can provide any suitable display in response to beginning a workout. In some embodiments, the display can include information corresponding to the user's workout progress. FIG. 4 is a schematic view of an illustrative display for providing information corresponding to an ongoing workout in accordance with one embodiment of the invention. Display 400 can include options 402 for controlling the workout. For example, options 402 can include a play/pause option for starting and pausing the workout. In particular, the play/pause option can be used to control the recordation of workout information by the sensors of the device. In some cases, the play/pause options can instead or in addition be used to control the playback of media (e.g., music) during the workout. The music playback can correspond to the workout, such that the music can play and pause at the same time as workout information is recorded.

In some embodiments, display 400 can be used to control the playback of media as part of the workout. For example, options 402 can include previous/next, or rewind/fast forward options for controlling the played back media items. The currently played back media item can be identified using any suitable approach, including for example using title bar 404. The title bar can include any suitable identifying information, including for example the media item title, artist, album, or other metadata corresponding to the media item.

Display 400 can include information corresponding to the workout. For example, display 400 can include workout time 410, workout distance 420 and workout pace 422. Each of the instances of information can be displayed in any suitable position, and with any suitable size. For example, each instance can have the same or different sizes. In some embodiments, the more relevant information can be displayed in a more prominent position. In display 400, time 410 can be displayed in the center of the display in a larger font, while distance 420 and pace 422 can be displayed near the top of the display in a smaller font. In some embodiments, other approaches can be used to change the prominence of one or more instances of information, including for example changing the color of the information.

Some electronic devices can have small displays on which limited amounts of information can be provided. For example, some electronic devices can have displays so small that only time 410 and one of distance 420 and pace 422 can be displayed at a single time on the display. As another example, some electronic devices can have displays so small that only a single instance of information can be displayed at a single time. Alternatively, several instances of information can be displayed, but in smaller size or prominence.

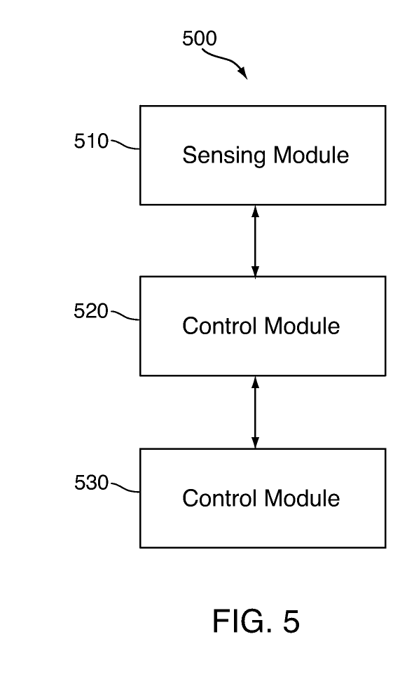

While working out, a user may move the device relative to his eyes. The constant or cyclical movement of the device may render it difficult for the user to read displayed information. Accordingly, the electronic device can automatically adjust the manner in which information is displayed to increase the prominence of displayed information. Because the display can have a limited size, the electronic device can select particular information to display more prominently. The electronic device can determine when to adjust the prominence of displayed content using any suitable approach. In some embodiments, the electronic device can detect movement of the device from the output of a sensor integrated with or coupled to the device. FIG. 5 is a block diagram of electronic device modules for adjusting a device display in accordance with one embodiment of the invention. Electronic device 500 can include control module 520 controlling the operations of the electronic device. Control module 520 can receive information from one or more sensors or sources providing information about the user's workout. For example, control module 520 can include communications circuitry for receiving an output from a sensor in a user's shoe. As another example, control module 520 can include an interface module for connecting to a plug associated with a workout machine.

To determine whether the device is moving so much as to require adjusting the device display (e.g., the device is moving more than a threshold amount relative to the user), control module 520 can receive an output from sensing module 510. Sensing module 510 can include one or more sensing devices (e.g., IMUs) integrated in the electronic device, or one or more sending devices in communication with the control module. For example, a sensing module can be attached to the user's body (e.g., attached with a clip to the user's clothing, or integrated on a watch worn by the user). The sensing module can provide any suitable output, including for example an output that reflects the movement of the device. The control module can analyze or review the output of the sensing module, and determine whether the movement corresponding to the output exceeds a threshold amount. For example, the control module can compare the amount of detected movement with a value corresponding to a level of movement at which it becomes more difficult to read displayed information (e.g., corresponding to movement at a particular speed, of a particular distance, or at a particular rate of change).

In response to determining that the device is moving more than the threshold amount, control module 520 can direct display module 530 to adjust the displayed information. For example, control module 520 can direct the display module to provide a display in which the most prominently displayed content is selected based on a template, a user selection, or a default selection. In some embodiments, the most prominently displayed content can be selected based on the workout selected by the user. Display module 530 can adjust the prominence of particular content using any suitable approach, including for example by changing the position, size, color, font, animation (e.g., a dynamic or changing display, such as a marquee bar), or other display attribute of content. In some embodiments, control module 520 can further adjust a display provided by display module 530 based on a user's progress in a workout, for example as determined from an output of sensor module 510.

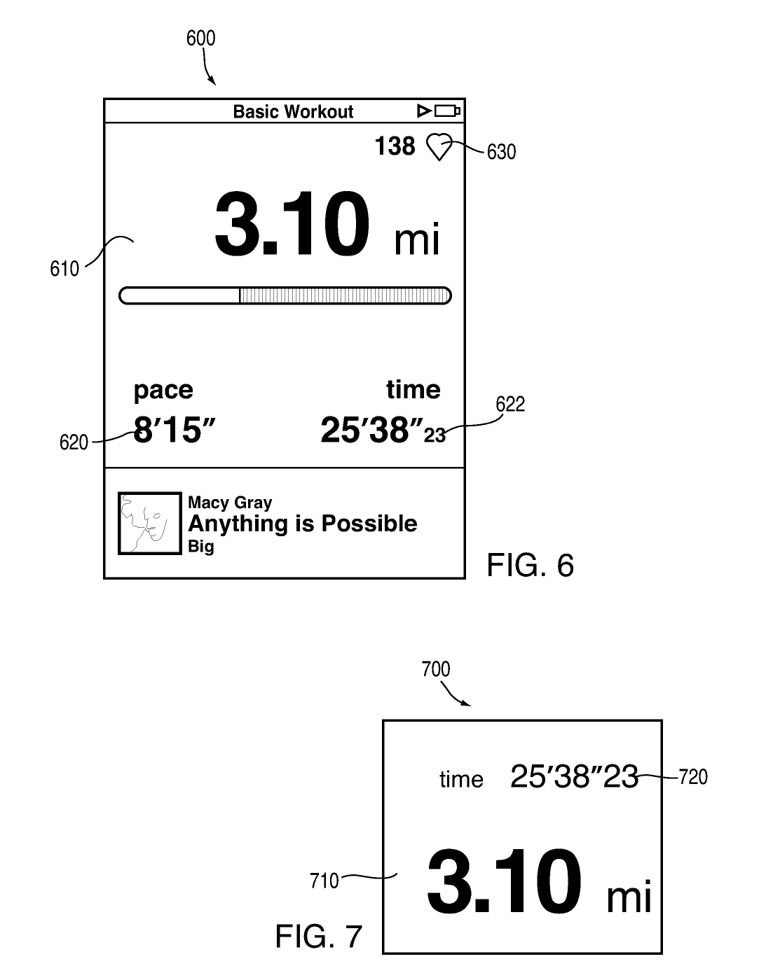

FIG. 6 is a schematic view of an illustrative electronic device display in which the prominence of displayed content is adjusted based on device movement in accordance with one embodiment of the invention. Display 600 can include different information provided in response to detecting that the device is moving. For example, display 600 can include distance 610 displayed using a first level of prominence, which can include a large type near the center of the display. Display 600 can be disposed such that there is room available for displaying only a single instance of information using the first level of prominence. Display 600 can in addition include pace 620 and time 622 displayed in a second region of the display (e.g., near the bottom of the display) using a second level of prominence. The second level of prominence can include a medium size type and a position in a band underneath the region associated with the first level of prominence. Display 600 can include heart rate information 630 displayed using a third level of prominence. The third level of prominence can include a small size type and a position in a band above the region of the first level of prominence. The type sizes associated with each of the levels of prominence can be selected based on any suitable criteria. For example, each type can be selected to be visible at different levels of movement (e.g., the first level of prominence is visible when running, and the second level of prominence is visible when jogging).

In some devices, the display can be so small that there may be insufficient space to display information with three levels of prominence. FIG. 7 is a schematic view of an illustrative display of information provided when the device moves in accordance with one embodiment of the invention. Display 700 can include distance 710 displayed at a first level of prominence, and time 720 displayed at a second level of prominence. The first level of prominence can include a large type and information displayed near a center region of the display, and the second level of prominence can include a smaller type and information displayed along an edge (e.g., the top edge) of the display. Unlike display 600 (FIG. 6), display 700 may not have enough space to display pace and heart rate information.

As a user runs or conducts a workout, the particular information of most interest to the user can change. For example, a user may initially be most interested in pace information (e.g., to make sure the user is running at a constant pace), but later be more interested in the distance or time ran (e.g., near the end of the workout). One approach for changing the information displayed can include a user providing a corresponding instruction. This may be difficult, however, while the user is working out or when the device is moving relative to the user. In some embodiments, the electronic device can instead automatically determine when and how to adjust displayed content.

In many cases, the user may be interested in different information based on progress of the user in a workout. In particular, the user may be interested in different information as the user approaches the end of a workout. For example, the user may be interested in information that relates to the manner in which the end of the workout is defined (e.g., distance in a distance-based workout, or time in a time-based workout). As another example, the user may be interested in information other than the metric by which the workout was defined (e.g., the time it took the user to reach the distance selected for the workout). By monitoring a data stream corresponding to the workout definition, the electronic device can determine the user's progress relative in the workout and automatically adjust the displayed content.

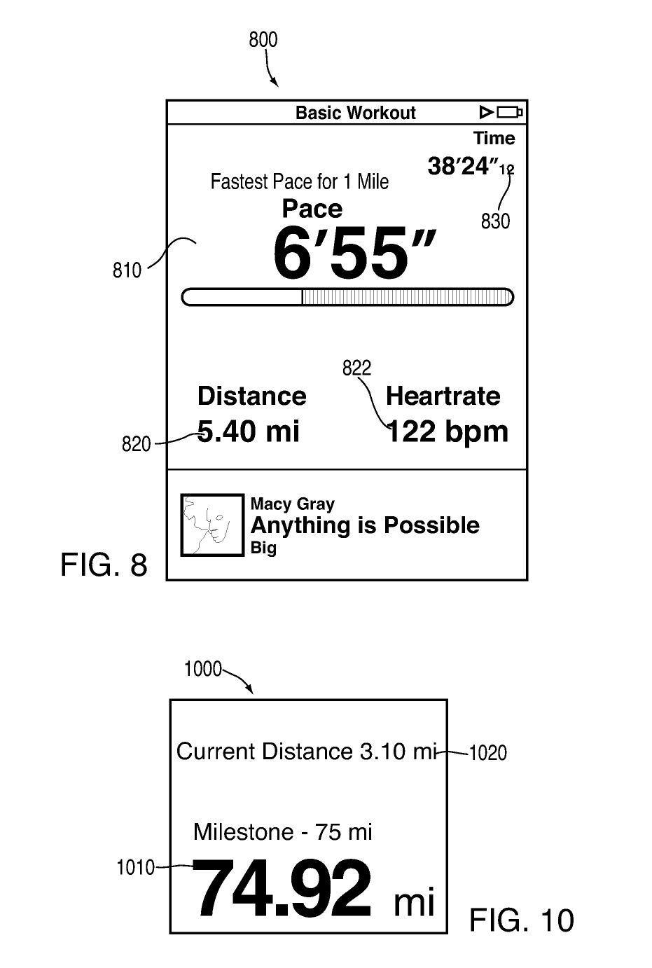

FIG. 8 is a schematic view of an illustrative electronic device display that is automatically adjusted based on a workout progress in accordance with one embodiment of the invention. Display 800 can include pace information 822 provided at a first prominence level, distance information 820 and heart rate information 822 provided at a second prominence level, and time information 830 provided at a third prominence level, where each of the prominence levels correspond to counterpart levels of prominence of display 600 (FIG. 6). In contrast with display 600, the particular information displayed at each level of prominence can differ. In particular, the most prominent information can change from distance to pace, while the least prominent information can change from heart rate to time.

The electronic device can determine which information to display based on a workout progress or other event using any suitable approach. In some embodiments, a particular type of information or metric can be associated with a workout. For example, a metric corresponding to the workout type can be identified. As another example, an overall performance metric (e.g., calories burned, or measured improvement) can be associated with a workout. In addition to the particular type of information or metric, a threshold can be associated with a workout. For example, an amount completed (e.g., as a percentage of the total workout) or a milestone (e.g., each mile or 5 kilometers) can be selected. As another example, the threshold can be dynamically adjusted based on prior performances (e.g., the last longest run plus or minus an amount or a percentage). In some embodiments, several types of information, several thresholds, or both can be associated a single workout.

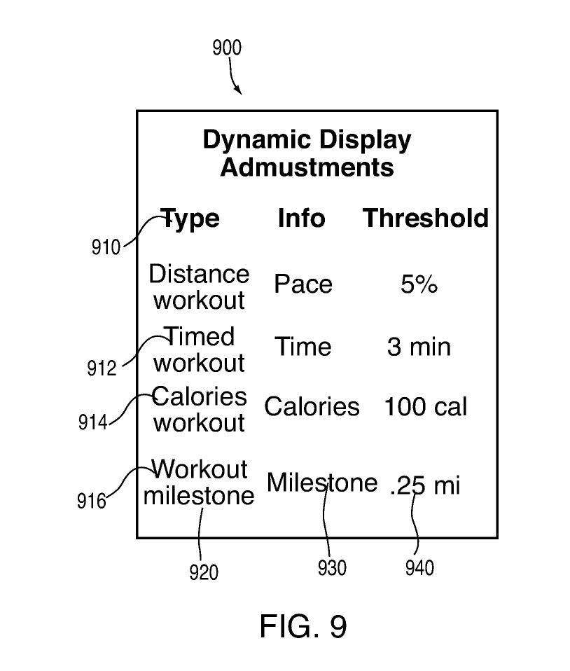

FIG. 9 is a schematic view of an illustrative display for defining a type of information and a threshold for dynamically adjusting the information displayed by a device in accordance with one embodiment of the invention. Display 900 can include column 920 of workout or event types, column 930 with the information to display, and column 940 with the threshold values. Display 900 can include a row for each workout or event type, including distance workouts 910, timed workouts 912, calories workouts 914 and milestone events 916. The user can define the values for columns 930 and 940 for each type of workout, such that the user can define the manner in which a display will change when the device determines that a workout or event is nearing a target or goal (e.g., the workout is nearing its completion).

In some embodiments, the electronic device can monitor performance over several workouts. For example, the electronic device can monitor the frequency of workouts, workout times and distances, or any other information that can be measured and compared across different workouts. More generally, the electronic device can monitor an ongoing event as well as a current event, which may or may not affect the ongoing event (e.g., walking using a pedometer application may not affect an ongoing workout tracker). In such cases, the electronic device can adjust the display not based on a value associated with a current workout, but rather based on a user's progression relative to the overall monitoring. The electronic device can then temporarily adjust the display (e.g., to indicate that the user has reached a milestone total distance, such as 50 miles), before returning to displaying information corresponding to the ongoing workout.

FIG. 10 is a schematic view of an illustrative display for providing information corresponding to a milestone event in accordance with one embodiment of the invention. Display 1000 can include milestone event information 1010 displayed with a first level of prominence, and ongoing information 1020 displayed with a second level of prominence, which can correspond to the levels of prominence described above in connection with display 700 (FIG. 7). Milestone event information 1010 can include any suitable event that can span several workouts, including for example long term workout goals or coaching targets. Ongoing information 1020 can correspond to information related to a current workout, such as distance, time, pace, heart rate, calories burned, or any other such information. In some embodiments, the particular information selected for display can correspond to the information previously displayed with the first level of prominence (e.g., the information that was replaced by milestone event information 1010).

The electronic device can display the adjusted information for any suitable duration. For example, the electronic device can display the adjusted information while a workout value ranges from the threshold value to a value corresponding to the end of the workout (e.g., the last 1/4 mile, or the last 2 minutes of the workout). As another example, the electronic device can display the adjusted information for a known duration (e.g., a fixed time or a percentage of the total workout duration). As still another example, the electronic device can display the adjusted information until a workout quantity reaches a termination value (e.g., when the distance reaches a milestone value, or when a pace increases for a following mile).

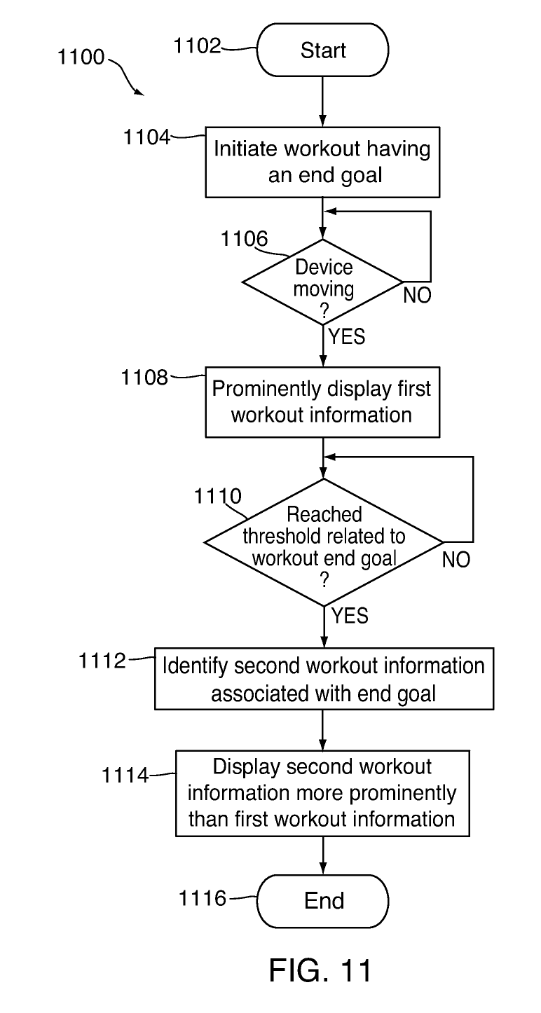

The following flowcharts describe illustrative processes used for dynamically adjusting information displayed by a device while the device display moves relative to the user. FIG. 11 is a flowchart of an illustrative process for dynamically adjusting a display of a device used in a workout in accordance with one embodiment of the invention. Process 1100 can begin at step 1102. At step 1104, the electronic device can initiate a workout having a defined end goal. For example, the electronic device can receive a workout definition having a target distance, duration, or calories burned. The workout definition can be provided by a user, or automatically generated as part of a workout scheme prepared for the user.

At step 1106, the electronic device can determine whether the device is moving. For example, the electronic device can determine whether the device is moving relative the user's eyes. In particular, the electronic device can monitor the output of a motion sensing component to quantify the amount of movement of the device. If the electronic device determines that the device is not moving, process 1100 can return to step 1106 and continue to monitor for device movement. If, at step 1106, the electronic device instead determines that the device is moving, process 1100 can move to step 1108. At step 1108, the electronic device can display prominently a first instance of workout information. For example, the electronic device can display information corresponding to the user's performance in the workout. The particular information displayed can be selected by the user, default information, information corresponding to a template, information corresponding to the end goal of the workout, or combinations of these. At step 1110, the electronic device can determine whether a monitored quantity or information corresponding to the workout has reached a threshold related to the workout end goal. For example, the electronic device can determine whether a monitored distance, time, or pace is within a threshold value of the end goal value provided to initiate the workout (e.g., if the user is within 250 meters of the end of a run). If the electronic device determines that the threshold has not been reached, process 1100 can return to step 1110 and continue to monitor for the threshold value.

If, at step 1110, the electronic device instead determines that the threshold value has been reached, process 1100 can move to step 1112. At step 1112, the electronic device can identify a second workout information that is associated with the end goal, where the second workout information differs from the first workout information. For example, the electronic device can retrieve a particular type of information that matches the end goal information type. As another example, the electronic device can retrieve information selected by the user for the type of workout corresponding to the end goal. At step 1114, the electronic device can display the second workout information more prominently than the first workout information. For example, the electronic device can replace the first workout information with the second workout information on the display. Process 1100 can then end at step 1116.

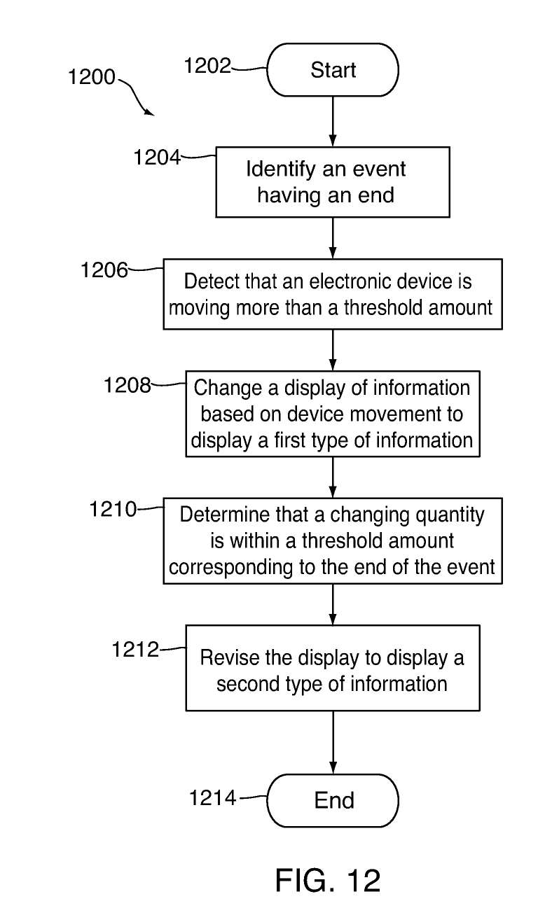

FIG. 12 is a flowchart of an illustrative process for dynamically adjusting a display based on an event. Process 1200 can begin at step 1202. At step 1204, the electronic device can identify an event having an end, where the end of the event is defined by a value of a changing quantity. For example, the electronic device can identify a workout having an end goal defined by a measurable quantity. At step 1206, the electronic device can detect that the electronic device is moving more than a threshold amount. For example, the electronic device can receive an output from a motion detection sensor indicating the relative movement of the device. At step 1208, the electronic device can change a display of information, where a first type of information is displayed at a first level of prominence. For example, the electronic device can increase the prominence of a first type of information in response to detecting that the device is moving.

At step 1210, the electronic device can determine that the changing quantity is within a threshold amount of the end value of the changing quantity. For example, the electronic device can monitor a data stream corresponding to the event, and determine when the data stream approaches the end value of the event. At step 1212, the electronic device can revise the display such that a second type of information different from the first type of information is displayed at the same level of prominence as the first type of information. For example, the electronic device can replace the first information with the second information on the display. Process 1200 can then end at step 1214.

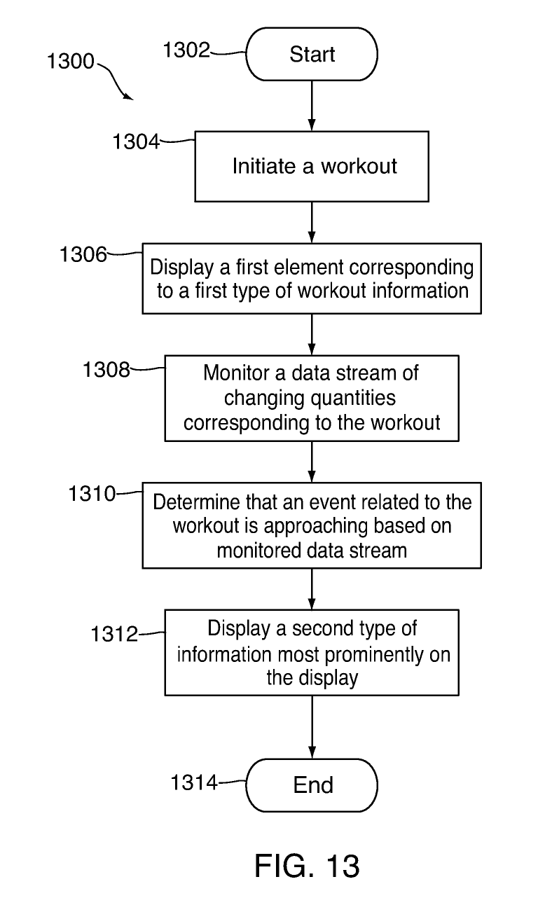

FIG. 13 is a flowchart of an illustrative process for adjusting a display provided during a workout in accordance with one embodiment of the invention. Process 1300 can begin a step 1302. At step 1304, the electronic device can initiate a workout. For example, the electronic device can receive a workout goal (e.g., a distance or time to run). At step 1306, the electronic device can display a first element corresponding to a first type of workout information. The first type of information can be displayed most prominently on the display (e.g., in the center of the display in a large type). At step 1308, the electronic device can monitor a data stream of changing quantities corresponding to the workout. For example, the electronic device can monitor a data stream provided from a sensor detecting foot impacts. At step 1310, the electronic device can determine if an event related to the workout is approaching. For example, the electronic device can determine whether the user has run a particular distance, at a particular pace, or for a particular duration. At step 1312, the electronic device can automatically display a second element corresponding to a type of workout information other than the first type. The second element can be displayed most prominently on the display. Process 1300 can then end at step 1314.

Although many of the embodiments of the present invention are described herein with respect to personal computing devices, it should be understood that the present invention is not limited to personal computing applications, but is generally applicable to other applications.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the invention are presented for purposes of illustration and not of limitation.

What is claimed is:

1. A method for dynamically adjusting content displayed by an electronic device, comprising:
identifying an event having an end, wherein the end is defined by a value of a changing quantity;
detecting that the electronic device is moving more than a threshold amount;
changing a display of information, wherein a first type of information is displayed at a first level of prominence in response to detecting;
determining that the changing quantity is within a threshold amount of the end value of the changing quantity; and
revising the display such that a second type of information different from the first type of information is displayed at the first level of prominence in response to determining.

2. The method of claim 1, further comprising:
receiving an output from a sensor detecting movement of at least one of the user and the device; and
determining, from the received output, that the electronic device is moving relative to the user by more than a threshold amount.

3. The method of claim 2, wherein the sensor comprises at least one of:
a motion sensing component integrated in the device; and
a sensing component coupled to the user.

4. The method of claim 1, wherein revising further comprises:
replacing the first type of information with the second type of information on the display.

5. The method of claim 4, wherein revising further comprises:
displaying the first type of information at a second level of prominence, wherein the second level of prominence is less prominent than the first level of prominence.

6. The method of claim 1, wherein a level of prominence comprises at least one of:
display region on the device;
font;
type size; and
color.

7. The method of claim 6, wherein the first level of prominence and the second level of prominence differ in at least two of:
display region on the device;
font;
type size; and
color.

8. An electronic device for displaying different information based on the progress of a workout, comprising a control module and a display module, the control module operative to:
initiate a workout having a workout goal;
direct the display module to prominently display a first category of workout information;
monitor progress of the workout;
determine that the workout is within a threshold amount of the workout goal; and
direct the display module to prominently display a second category of workout information instead of the first category of workout information in response to determining that the workout is within the threshold amount.

9. The electronic device of claim 8, further comprising a sensor module, wherein the control module is further operative to:
receive an output from the sensor module corresponding to the execution of the workout; and
retrieve the workout progress from the received output.

10. The electronic device of claim 9, wherein the control module is further operative to:
receive an output corresponding to steps of a user during the workout.

11. The electronic device of claim 8, wherein:
the workout goal comprises a measurable quantity; and
the measurable quantity is of the second category of workout information.

12. The electronic device of claim 8, wherein:
the threshold amount is determined based on the category of workout information of the workout goal.

13. The electronic device of claim 12, wherein the control module is further operative to:
retrieve a user association of threshold amounts and the category of workout information of workout goals.

14. The electronic device of claim 8, wherein the workout goal comprises one of:
distance;
time; and
calories burned.

15. A method for dynamically adjusting display elements provided on a display, comprising:
initiating a workout;
displaying a first element corresponding to a first type of workout information, wherein the first element is a most prominently displayed element;
monitoring a data stream of changing quantities corresponding to the workout;
determining, from the data stream, that an event in the workout is approaching; and
automatically displaying a second element corresponding to a type of workout information other than the first type, wherein the second element is the most prominently displayed element.

16. The method of claim 15, further comprising:
identifying a milestone event associated with a user, wherein the milestone event corresponds to workout information accumulated over several workouts; and
determining that the milestone event is approaching.

17. The method of claim 15, further comprising:
retrieving a quantity of the data stream associated with the event;
retrieving a threshold associated with the event, wherein the threshold comprises a threshold quantity; and
determining that quantities of data stream have reached the threshold quantity.

18. The method of claim 15, further comprising:
replacing the first display element with the second display element.

19. The method of claim 18, further comprising:
displaying a third display element corresponding to the first type of workout information, wherein the third display element is displayed simultaneously with the second display element.

20. A computer readable media for dynamically adjusting content displayed by an electronic device, the computer readable media comprising computer program logic recorded thereon for:
identifying an event having an end, wherein the end is defined by a value of a changing quantity;
detecting that the electronic device is moving more than a threshold amount;
changing a display of information, wherein a first type of information is displayed at a first level of prominence in response to detecting;
determining that the changing quantity is within a threshold amount of the end value of the changing quantity; and
revising the display such that a second type of information different from the first type of information is displayed at the first level of prominence in response to determining.
